(19) United States
(12) Patent Application Publication
(10) Pub. No.: US 2016/0358231 A1
(43) Pub. Date: Dec. 8, 2016

(54) INTERACTIVE VIDEO PLAYER

(71) Applicant: James Finlaw, Denver, CO (US)

(72) Inventor: James Finlaw, Denver, CO (US)

(21) Appl. No.: 15/171,425

(22) Filed: Jun. 2, 2016

Related U.S. Application Data
(60) Provisional application No. 62/170,837, filed on Jun. 4, 2015.

(51) Int. Cl. G06Q 30/02; G06F 3/0482; H04L 29/06; G06F 3/0485

(52) U.S. Cl. CPC G06Q 30/0277; G06F 3/0485; G06F 3/0482; H04L 65/60

(57) ABSTRACT

A method of using an interactive video system has the steps of a user opening a promotional page comprising at least one video pane containing video content, and an ad pane containing web content, the user watching at least one video while interacting with the web content of the ad pane, wherein the user scrolls through the web content and selects a link that interests the user, wherein the video content continues playing uninterrupted and the web content is retrieved from a server. A system for providing interactive video has at least one video pane containing video content that is playing, at least one ad pane comprising web content, a background on which the video pane and ad pane are positioned, wherein a user interacts with the web content, wherein when links are clicked the web content changes while the video continues playing.

### CROSS-REFERENCE TO RELATED APPLICATION(S)

The present application claims priority to U.S. Provisional Patent Application No. 62/170,837 filed on Jun. 4, 2015, entitled “Viewer to Visitor” the entire disclosure of which is incorporated by reference herein.

### BACKGROUND OF THE INVENTION

### 1. Field of Invention

The present invention relates to the field of interactive video applications. In particular it relates to interactive web content being shown alongside video content.

### 2. Background of the Invention

In the prior art, YOUTUBE shows videos made by users. The YOUTUBE interface shows a number of comments from other users below the video, and other suggested videos may be scrolled through on the right side, whereas menu bar options “My Channel, Trending, Subscriptions, History and Watch Later” as well as subscriptions positioned below, are shown on the left side. A subscription opens a number of videos associated with the channel. While these subscriptions and suggested videos may be seen while the video is playing, once a selection is clicked, it interrupts the video that is being viewed and moves to a new page, wherein a new video may be opened.

The video may also have graphics superimposed thereon in a separate layer wherein the graphics comprise buttons having clickable links that allow a viewer to subscribe to the YOUTUBE channel or to access other related videos. In all cases when such a button is pushed, the current video is abandoned and a new page is opened. The location of the URL to which the browser is to jump may be embedded in the layer, and when the button is clicked the video stops and a new page is loaded.

In-line embedded advertising video in text may not be contextual with the content of the webpage it is embedded on. If the user clicks on the video, his or her current page is departed from and a new page is loaded. In addition to removing the user from the content that he or she was consuming, the video which the user was paying attention to is also replaced by a new window with new content.

Today, video is utilized in a number of ways for marketing and promotions. The two main categories of video hosting are popular sites like YouTube, Vimeo, etc and on their own websites. In all of these cases, a viewer will be launched into another page when performing any of the actions. With reference to FIGS. 9-17, it is possible to review the limitations of YOUTUBE and similar services.

Instances on YouTube Where an Action (Click) Causes User to View New Website and Lose Original View of Videos
clicking on publishing party's advertisement
clicking on ad on the right while watching video
clicking on text ad overlay inside video
clicking on banner advertisement overlay inside video
ad text advertisement for a sponsoring advertiser

Instances on Company Websites Where an Action (Click) Causes User to View New Website and Lose Original View of Videos
clicking on publishing parties content
ad text advertisement for a sponsoring advertiser
clicking pre-roll (paid advertising placed before selected video) advertisement video

With respect to FIG. 9, the user responds in YOUTUBE environment by clicking on publishing parties advertisement. In FIG. 10, the user responds in YOUTUBE environment by clicking on ad on the right. With regard to FIG. 11, the user responds in YOUTUBE environment by clicking on text ad overlay inside video. In FIG. 12, the user responds in YOUTUBE environment by clicking on banner advertisement overlay inside video. In FIG. 13, the user responds in YOUTUBE environment by clicking ad text advertisement for a sponsoring advertiser. In FIG. 14, the user responds in a company's own website environment, wherein HGTV is shown as an illustration, by clicking ad text advertisement for a sponsoring advertiser. In FIG. 15, the user is immediately pushed off the main page to a second page, leaving the original video site. In FIG. 16, the user responds in a company's own website environment (here HGTV for illustration) environment by clicking pre-roll (paid advertising placed before selected video) advertisement video. The user is immediately pushed off the main page to a second page, leaving the original video site. In FIG. 17, the user responds in a company's own website environment, wherein 9News is shown as an example, by clicking video on company website. The user is immediately pushed off the main page to a second page, leaving the original video site. A similar result is obtained by clicking pre-roll (paid advertising placed before selected video) advertisement video. While most of the screen shots shown are from YOUTUBE, the same dynamic of click on Calls to Action on a Website and then bouncing to another site apply on a customer's own website (see FIGS. 14-16).

One solution to the problem of the browser jumping away from the current video when either the content overlaid on the video or the content at the side or around the video is clicked, is to have two browser windows open, where one window plays the video and the other window permits use of the browser for searching web sites. A click on the materials on the second browser page will not stop the video playing on the first. However, this requires some user skill to set up and is not a natural use of the browser window, however this still does not allow user to i) watch video while still interacting with advertisement displayed on the same page of the video without leaving current website, and ii) respond to an advertisement displayed on the page and still be able to view video while interacting with advertisement.

Based on the foregoing, there is a need in the art for an interactive video player which permits a user to consume web content while viewing a video, wherein clicking on links within the web content permits the user to navigate through the web content without interrupting the video content.

### SUMMARY OF THE INVENTION

A method of using an interactive video system has the steps of a user opening a promotional page comprising at least one video pane containing video content, and an ad pane containing web content, the user watching at least one video while interacting with the web content of the ad pane, wherein the user scrolls through the web content and selects a link that interests the user, and the ad pane switching to the linked page when the link is selected, wherein the video content continues playing uninterrupted and the web content is retrieved from a server.

The method may have the additional step of the user viewing a list of one or more videos relating to the video content, and the step of the user switching between videos shown on the video list by clicking on them.

The web content may be html content, and a link to the content or to the video may shared by the user with one or more other users. The web content server may be a remote server, and the video content may be provided by a remote server. The ad pane content changes according to a pre-determined schedule, or according to the video content that is playing.

A system for providing interactive video has at least one video pane containing video content that is playing, at least one ad pane comprising web content, a background on which the video pane and ad pane are positioned, wherein a user interacts with the web content, wherein when links are clicked the web content changes while the video continues playing. In an embodiment, the video pane and ad pane usage statistics are tracked.

The system may also have a video selection bar, from which a user may select a selected video, and wherein the video pane changes to show the selected video. The ad pane may connected to a real-time booking engine to let users browse vacation videos and book the vacation at the same time.

The ad pane content changes according to a pre-determined schedule, or to the video content that is playing.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a functional view of user interaction of the video viewing system, according to an embodiment of the present invention;

FIG. 2 is a functional view of the backend of the interactive video system, according to an embodiment of the present invention;

FIG. 3 is a connectivity view between users of the interactive video system, according to an embodiment of the present invention;

FIG. 4 is a functional view of the transaction tracking of the interactive video system, according to an embodiment of the present invention;

FIG. 5 is a data flow view of the interactive video system, according to an embodiment of the present invention;

FIG. 6 is an example screenshot of the interactive video system, according to an embodiment of the present invention;

FIG. 7 is an example screenshot of the backend of the interactive video system, according to an embodiment of the present invention;

FIG. 8 is a state diagram of the shop by video portal, according to an embodiment of the present invention;

FIGS. 9 to 17 are prior art showing and explaining the problems of the prior art that are addressed by the present invention;

FIG. 18 is a screen shot showing some benefits of the invention;

FIG. 19 is a screen shot of the provision of embedding code, according to one embodiment;

FIG. 20 is a screen shot showing the user interface, in an embodiment of the invention;

FIG. 21 is a role diagram showing the role of the business client and customer, according to an embodiment of the present invention;

FIG. 22 shows an optional scroll view feature, according to an embodiment of the present invention; and

FIG. 23 shows a variety of formats for the system, according to an embodiment of the present invention.

### DETAILED DESCRIPTION OF PREFERRED EMBODIMENTS

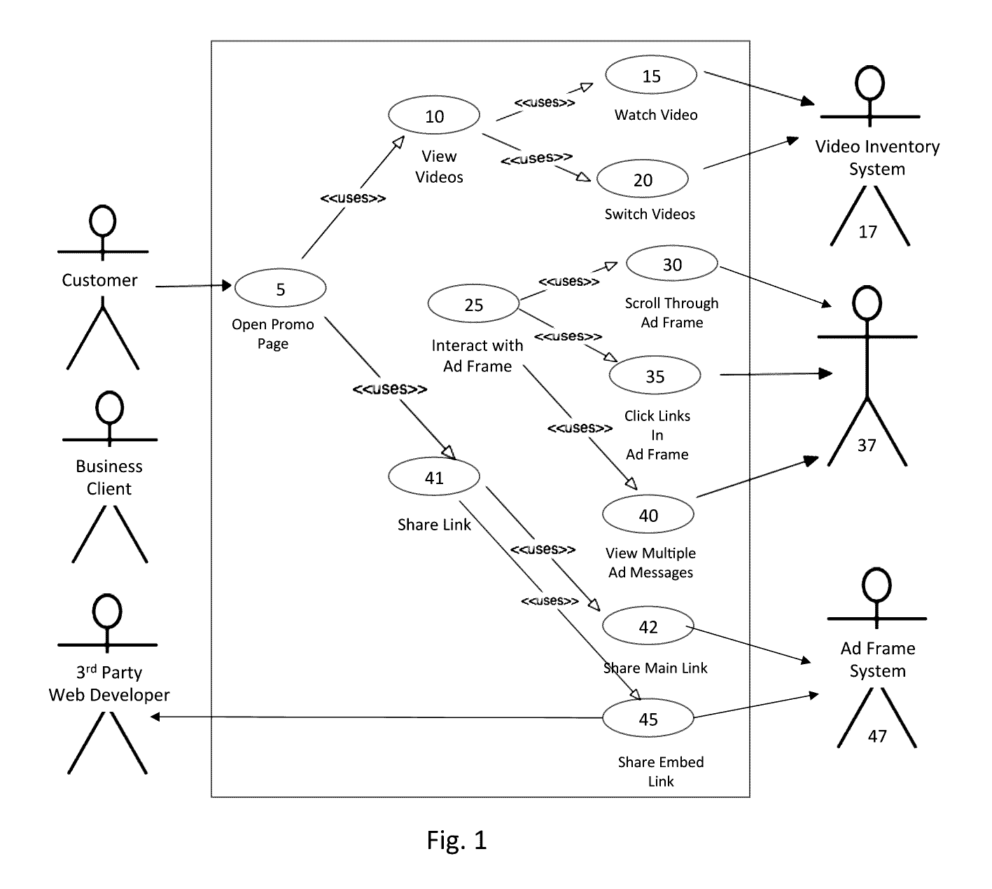

Preferred embodiments of the present invention and their advantages may be understood by referring to FIGS. 1-8, wherein like reference numerals refer to like elements.

Currently companies spend large budgets to produce professional videos. They also have specific campaigns designed to sell products or services. This interactive player allows there to be uniformity or connection between the video and the promotional point of purchase. Videos are known to be very emotionally engaging and the goal of the invention is to allow a viewer to purchase the item or service mentioned in the video without discontinuing the original video content. This would be of great value to industry in that it ties together two of the largest expenditures of a marketing campaign: creative video and custom advertising campaigns. Further it allows companies to fully utilize their investment in video, giving them new opportunities to maximize investments in creative video they may have already spent. Finally, tracking capabilities allow the company to refine its messaging and offers in a timely manner by determining which campaigns produced the most conversions. This invention maximizes the connection between a video and a Call to Action.

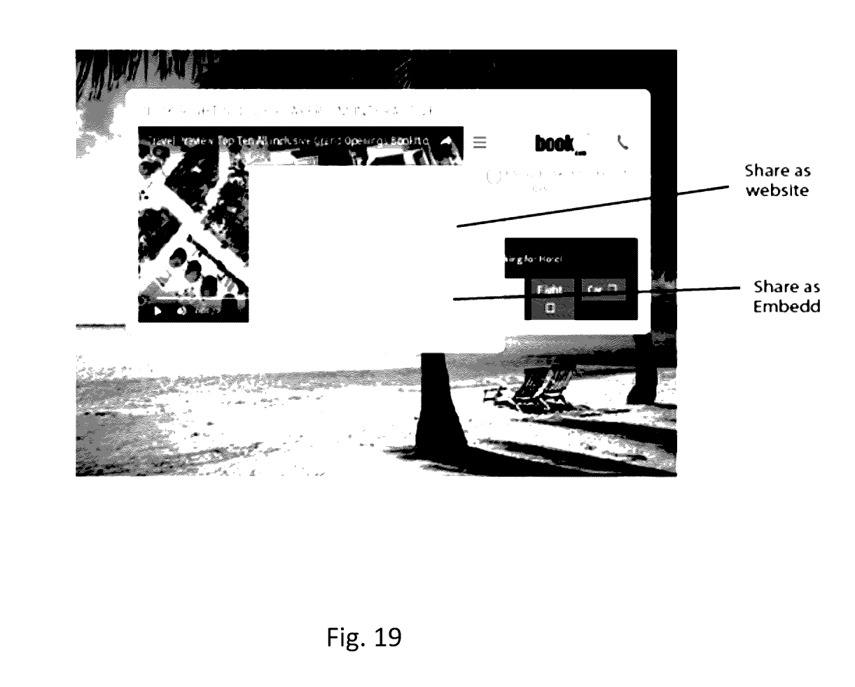

With reference to FIG. 1, in step 5 the customer opens a promo page comprising at least one video pane containing video content and one ad pane containing html. The customer may trigger the creation of the promo page by clicking on or mousing over an ad, wherein the promo page may be embedded in the content page the user has been previously viewing wherein he or she encountered the ad. In step 10 optionally the user views a list of the one or more videos which contains information relating to the ad originally clicked by the user. In step 15, the user watches at least one video at a time, and in step 20, the user may switch between the videos shown in the video list by selecting a further video from the video list, which then commences viewing within the video frame. In either step 15 or 20, the system is drawing on the video system inventory 17, comprising a local or remote database of video content. In step 25 the user interacts with the ad pane, comprising the at least one webpage adjacent to the video pane. In step 30, the user may scroll through the ad pane, and in step 35, may click links in the ad pane. When a link is clicked, the ad frame web page switches to the linked page, and the page refreshes while the video continues to play unaffected. In step 40, the user may view multiple ad messages within the ad pane, wherein the ad messages may be separated by time. In any of steps 30, 35, or 40, the content is drawn from one or more local or remote web server(s) 37 which provide advertising or web content. In step 41 a link to the content or to the video is shared by the user with one or more other users, and in step 42, the direct link is shared to link a receiving user 47 directly with the content. In step 45, the line of HTML code is provided to the user for sharing with others 47, for embedding the interactive video system within a web page. The embed code may be shared with a third party web developer 49 instead (see for example FIG. 19), who may insert it into a webpage, to provide an embedded version of the system.

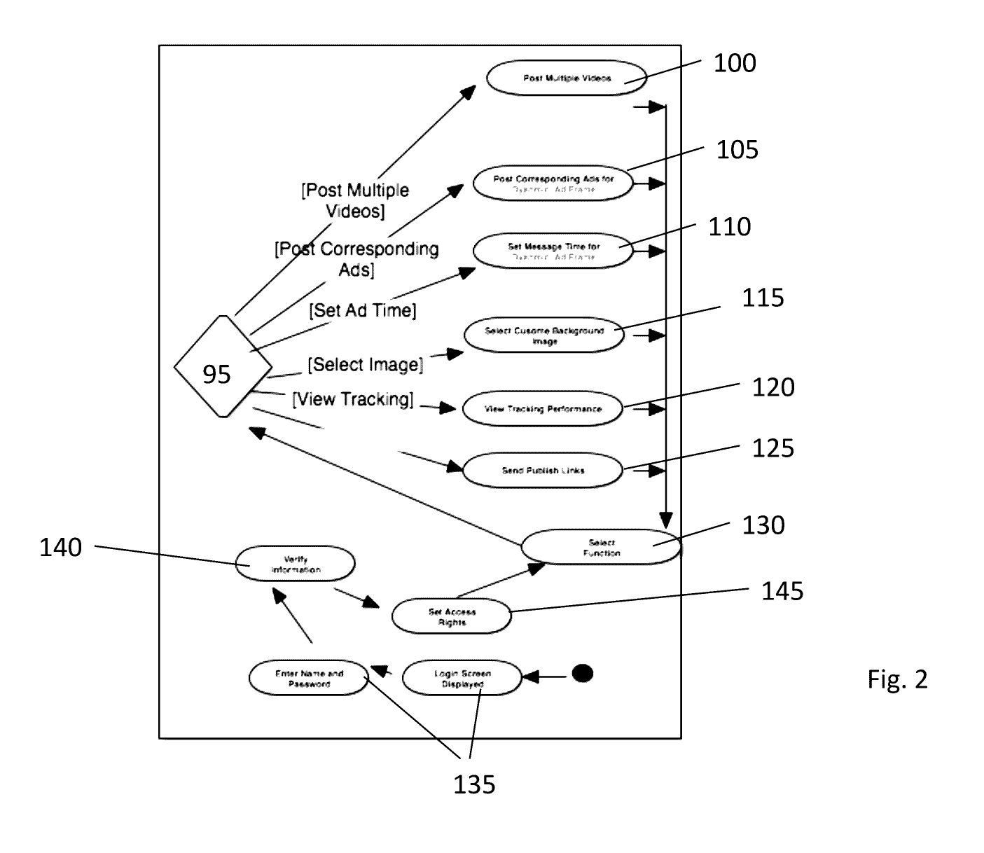

With reference to FIG. 2, a functional diagram of the setup and operation of the backend if the interactive video system is shown. The interactive video system comprises at least a video pane and an ad pane, both within the same screen and positioned on a background. There may be more than one video pane and more than one ad pane, and the ad pane may contain html and/or browsable web content. In step 100, the operator 95 posts one or more videos on a server that feeds the user client computers with the video content in the video frame. In step 105, ads for the ad pane corresponding to each of the videos are posted to the server. In step 110, if using the optional dynamic ad pane feature, the ads may be scheduled for delivery while the viewer is watching the video, either by time, for example a first ad is shown at the commencement of the video, a second replaces the first at 20 seconds into the video, a third replaces the second at 40 seconds into the video) or by trigger in the video playback, wherein a first ad is shown in the pane beside the video upon commencement of the video, and when the video hits the 20-second mark, it triggers the replacement of the first ad with the second, and so on at the 40-second mark. In step 115 the background for the interactive video system is shown, wherein the background appears behind the video pane and web content/ad pane. In step 120, the video viewing pane usage and characteristics are tracked as well as the characteristics of the ad pane(s), and the tracking performance may be viewed by the operator. Examples of the tracked characteristics are views, clicks, number of views on video, number of clicks within right pane, and mouse movement over interaction web content pane. The operator sends one or more publish links in step 125 that enable the interactive video system to be published on other websites as links or embedded content. In step 130, the operator selects the function based on feedback from the videos and ad panes, and tracking information. In step 135, the login screen requires the login name and password from the user. In step 140 the information is verified with a user login record on the server, and in step 145 the operator may set access rights for the interactive video player, so the content may be viewed only be selected users. Before each video pane or ad pane is shown, the access rights are verified for the user to ensure that only content that has been approved for the user is shown. In one embodiment the password protection is mainly for the business client when setting up the campaign.

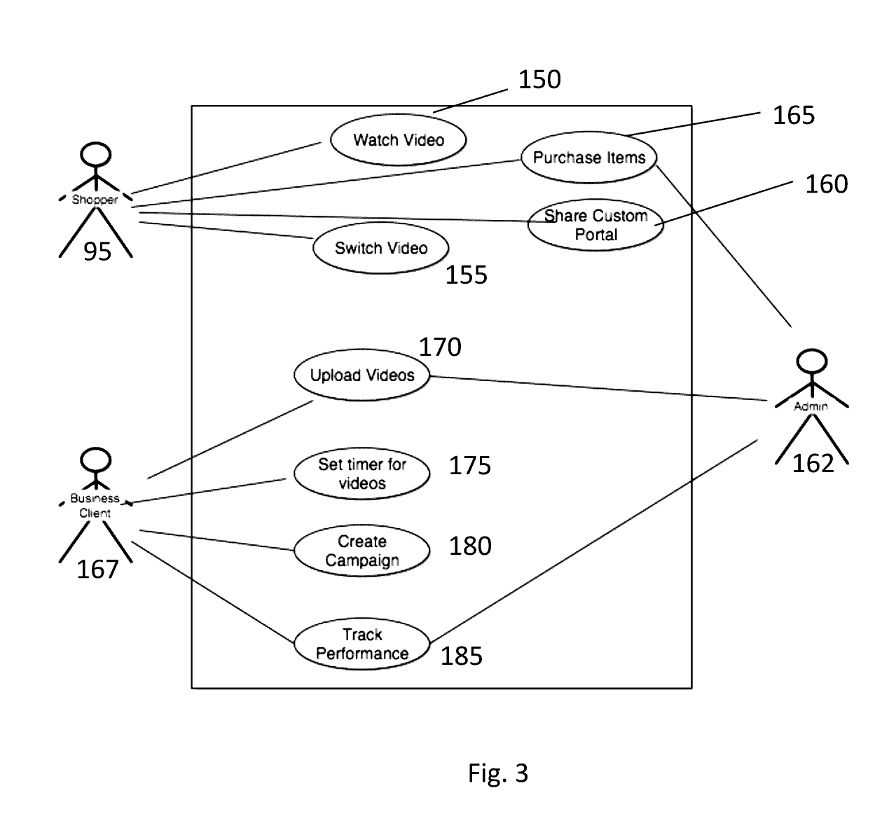

With reference to FIG. 3, the user or shopper may watch videos, along with the associated ad pane, in step 150. In step 155, the user may switch videos from the selection bar provided. In step 160, the custom portal is shared with other users by the current user. In step 165, the user may also purchase goods or services through the ad pane, wherein the ad pane reverts to a shopping cart system and payment window for the user to complete their purchase is provided, interfacing with the merchant directly or administrator 162, while the video continues to play in the video pane. The advertiser or business client 167 may upload videos in step 170, may set the timing for ad display using the optional dynamic ad display feature in step 175, may create an advertising campaign at step 180 and may track performance at step 185, wherein various metrics may be tracked.

| Metric | Operation |
|---|---|
| Views | Reports the number of video views within |
| | this specific app and specific video |
| Clicks | Reports the number of interactions in right |
| | side of pane |

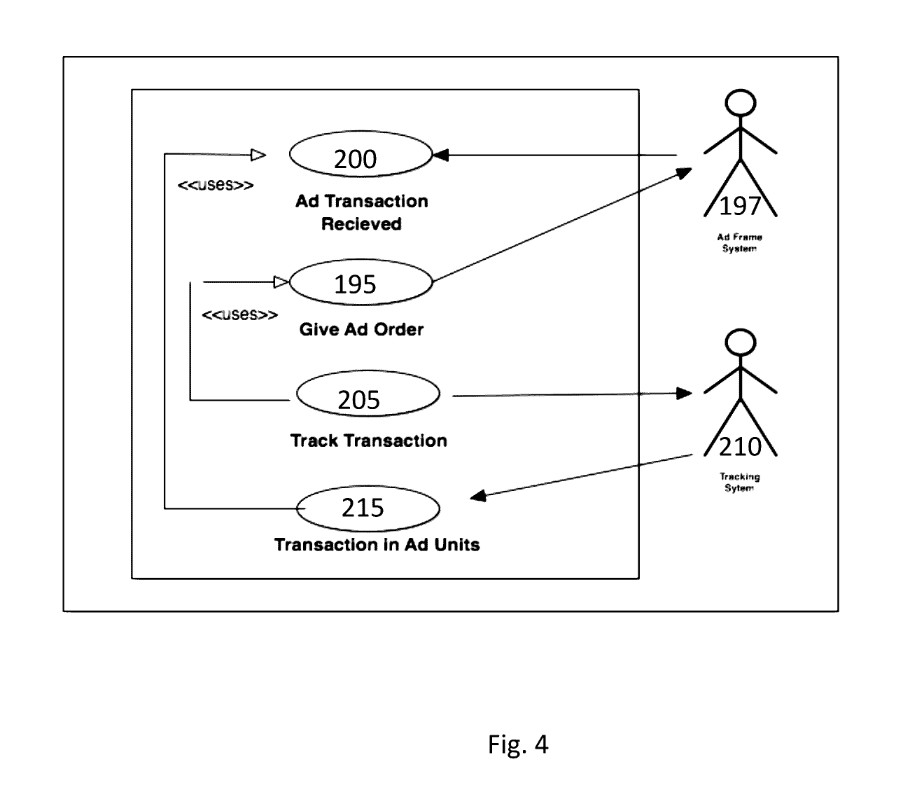

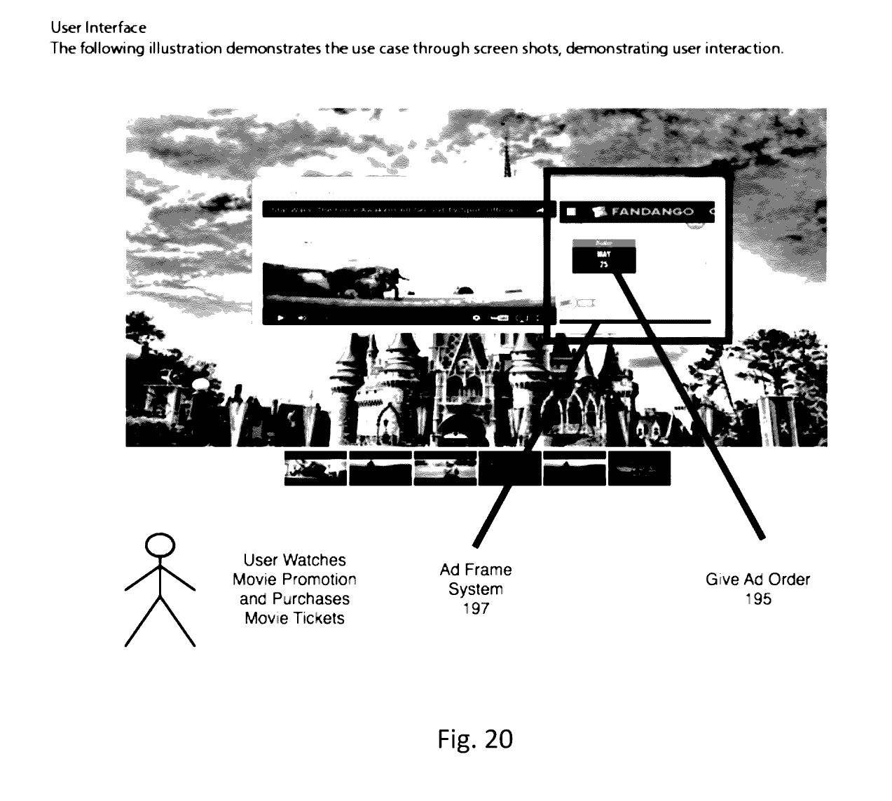

With reference to FIG. 4, the invention is visualized at the System Level. Below illustrates this system in operation through actual transaction (in this example the purchase of movie tickets while watching preview, in FIG. 20). At step 195 the ad frame system 197 receives the ad order, and in step 200 an ad transaction is received from the interactive video system's ad pane. The ad order is tracked in step 205, wherein it provides feedback on clicks and interaction to the tracking system 210, which records the transaction in the ad units database at step 215. In the example of the purchase of movie tickets, the tracking system would report the transaction.

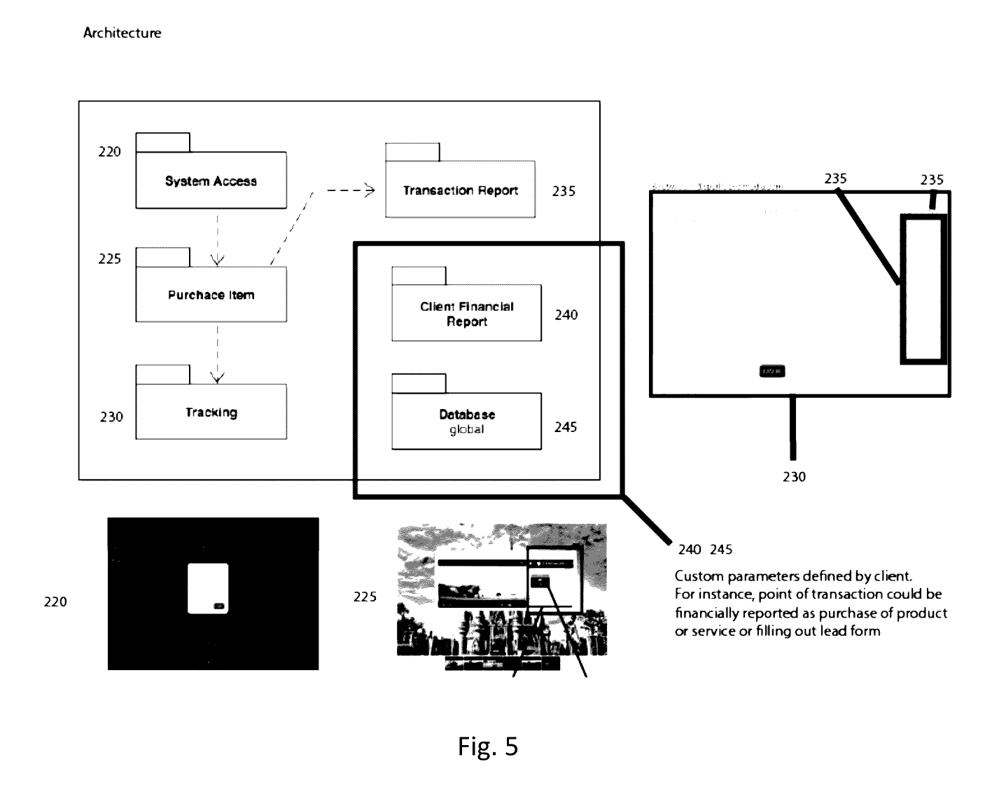

With reference to FIG. 5, the architecture of the invention is shown, wherein system folders (databases) are shown, wherein system access database 220 stores the userids and passwords, along with access restrictions and permissions for each user, are stored. The purchase item database 225 receives data from the system access database and provides data to the tracking database 230 and transaction report database 235, which records the transactions. The client financial report database 240 contains payment transactions for clients, and the database global 245 permits international dissemination of the data.

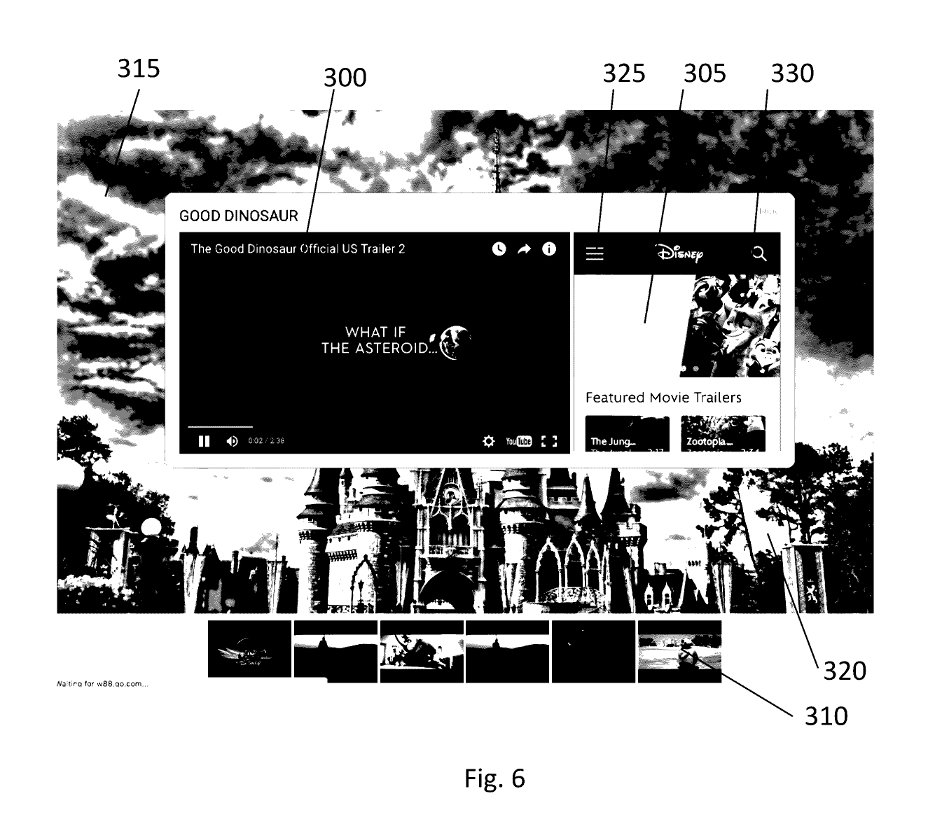

With reference to FIG. 6, the invention interface is designed to inherit the banners ads and texts from YOUTUBE or other hosting, wherein an example screenshot of the interactive video system is shown, containing at least one video pane 300, at least one ad pane 305 containing html and/or other interactive content, which may be browsed independently and does not interrupt the video playing. The video content may be streamed from a third party site such as YOUTUBE. The video and content are curated in one embodiment.

The ad pane may be linked to a real time booking engine, in the case of a travel theme. The video list 310 contains additional videos that may be selected to play, wherein selecting a video changes the video content of the video pane 305 and, optionally, the interactive content of the ad pane. The focus of the interaction is that between the video pane (on the left in the figure) and the web site pane or ad pane, providing a point of purchase (on the right in the figure).

The video pane and ad pane are positioned on a background 320 that may be thematically linked to the video list theme. The ad pane may contain alterable settings 325 and a search functionality 330, and scrollable, clickable content. Scrolling through the content does not changes the playing of the video in the video pane 300.

Below are some examples of the types of content that may appear in ad pane:

| | Types of Content in Ad | Identified Point of |
|---|---|---|
| Industry | Pane | Purchase |
| Travel | Client's own booking | Purchase hotels, |
| | engine | flights etc |
| Entertainment | Display movie times, | Purchase Movie |
| | prices | Tickets |
| Professional Services | Contact Form Fill | Lead Generation |
| Training Services | Offer to take Course | Enrolls in Courses |
| Professional Sports | Purchase Event Tickets | Buys tickets or |
| | or Merchandise | merchandise |
| Clothing and Apparel | Catalog of items | Order items online |

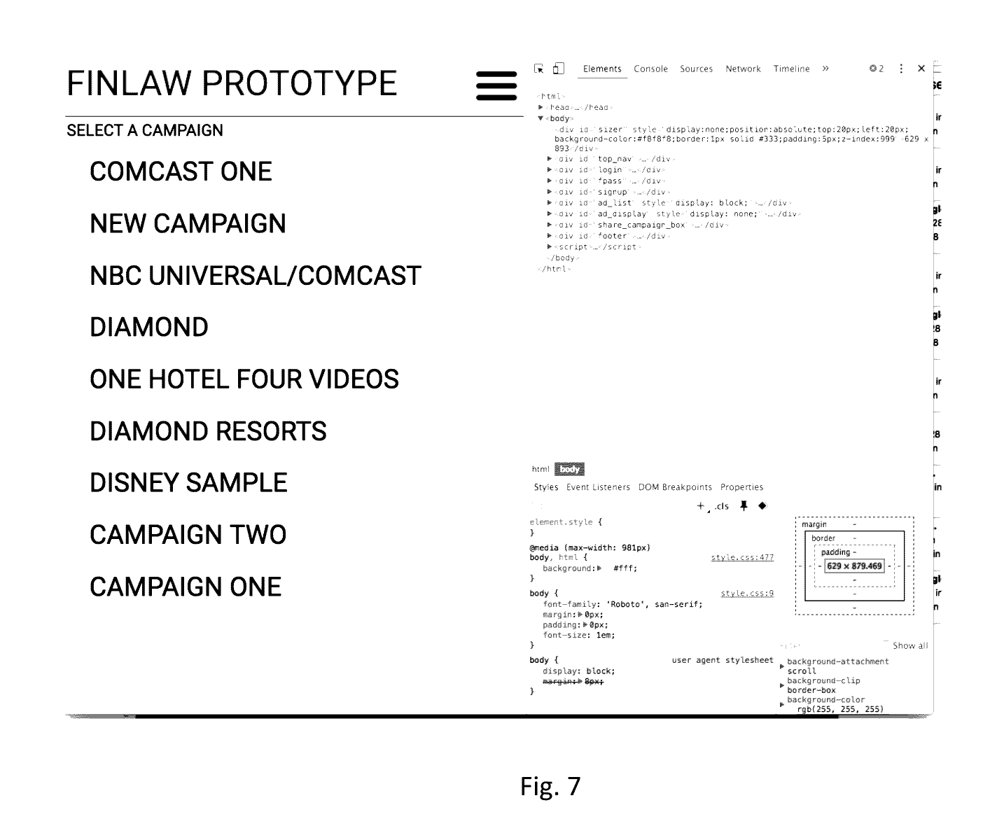

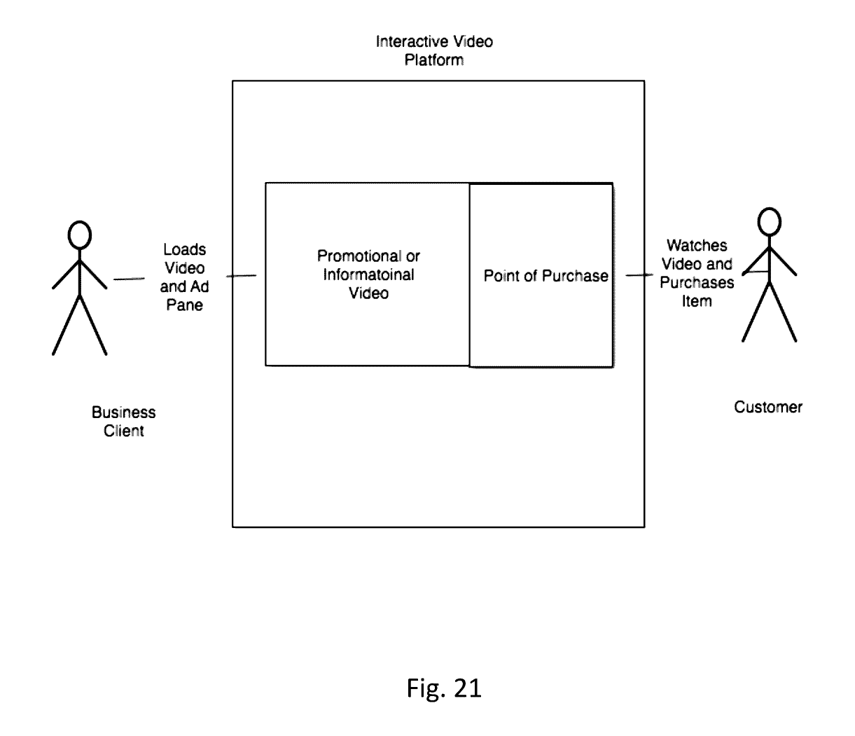

FIG. 7 shows the business client interface for organizing the video and ad pane content, and creating online campaigns. In this example, on the left are a number of campaigns that the user is able to edit. Once an ad is selected, the html organization of the page is coded in the top right window, and the styles are coded in the lower right section. The appearance of the interactive video system is also shown with borders. However, there are a number of different ways that the system may be configured through a backend. In FIG. 21 is an illustration of this process.

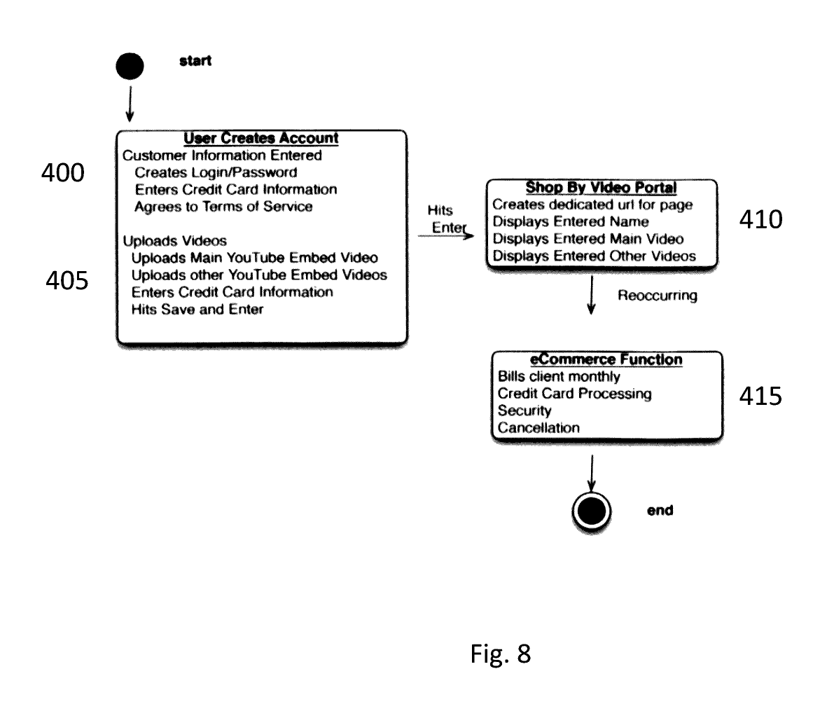

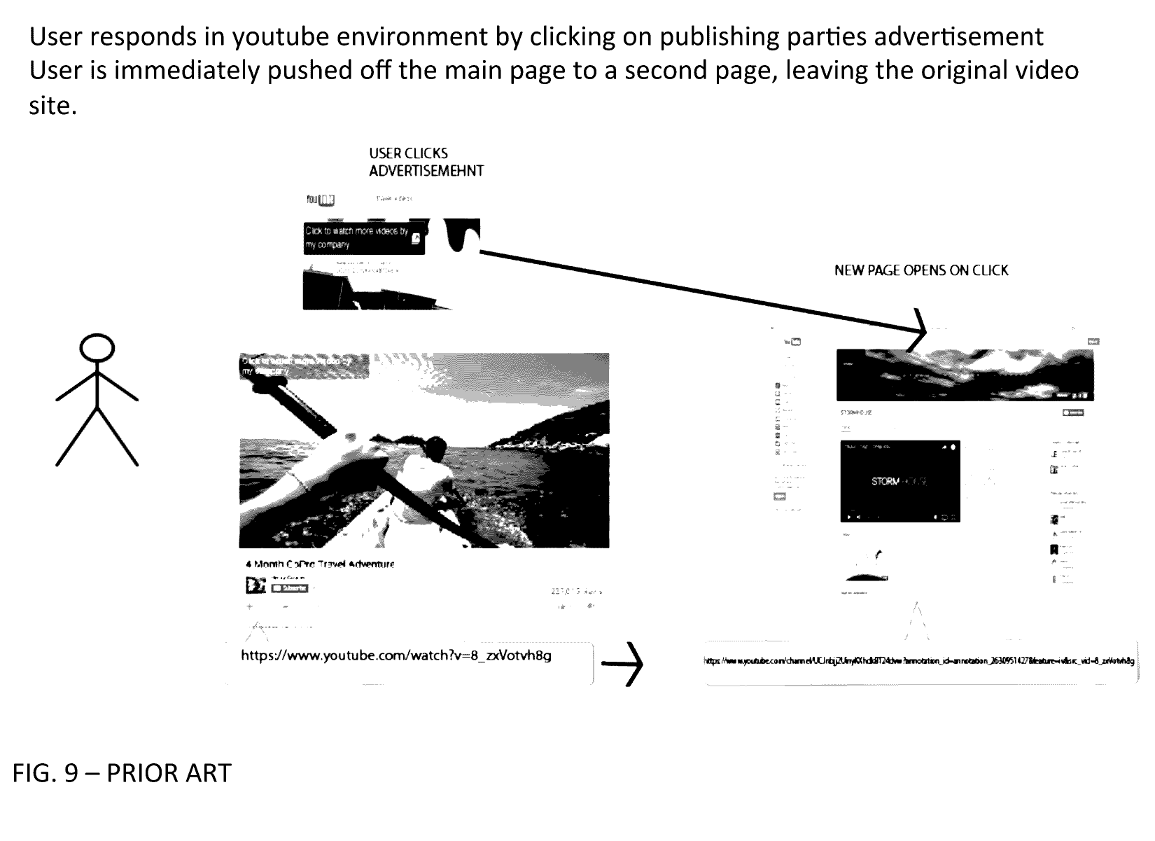

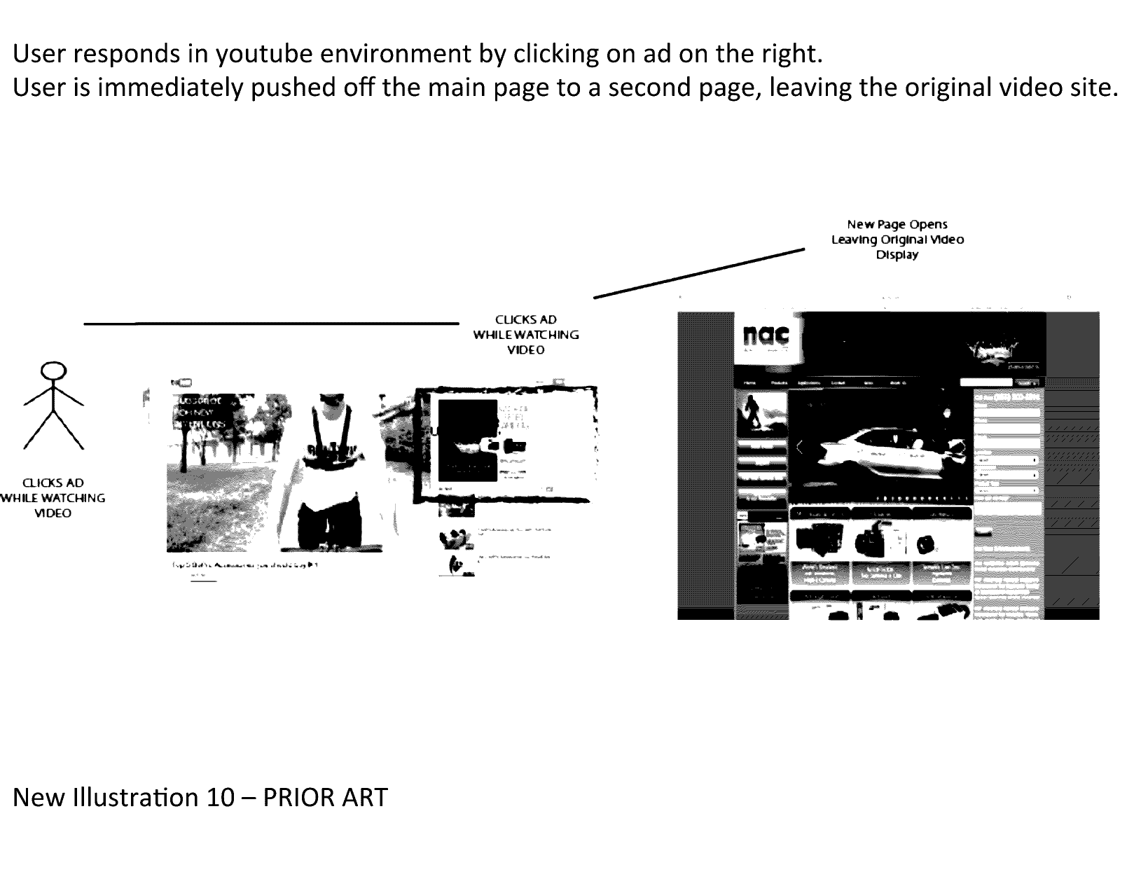

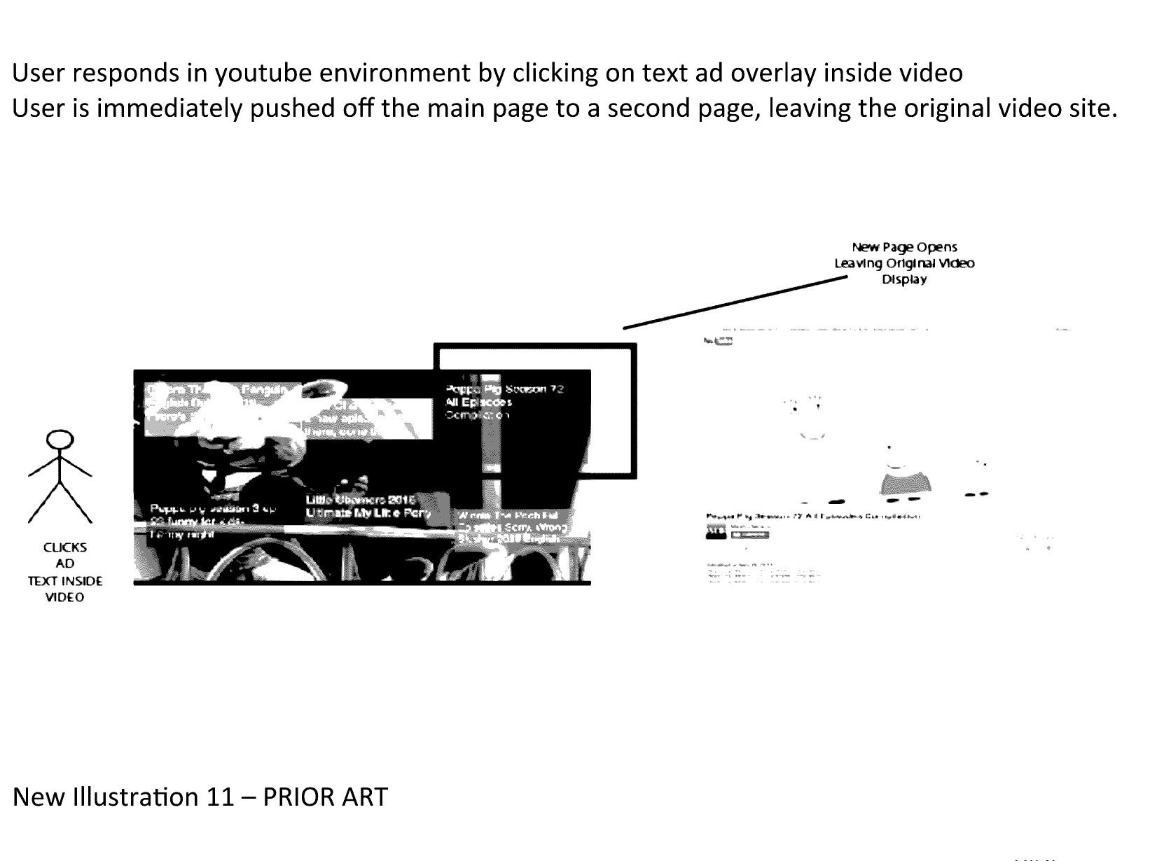

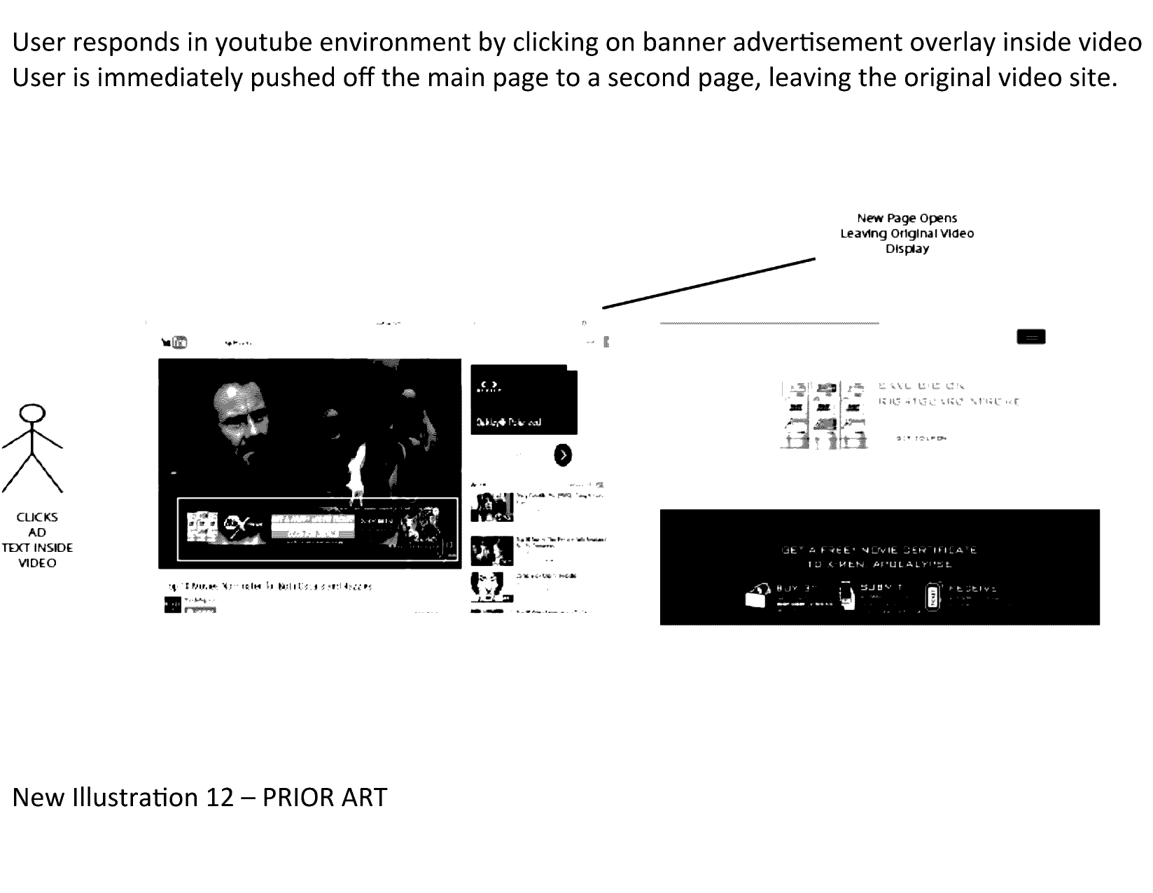

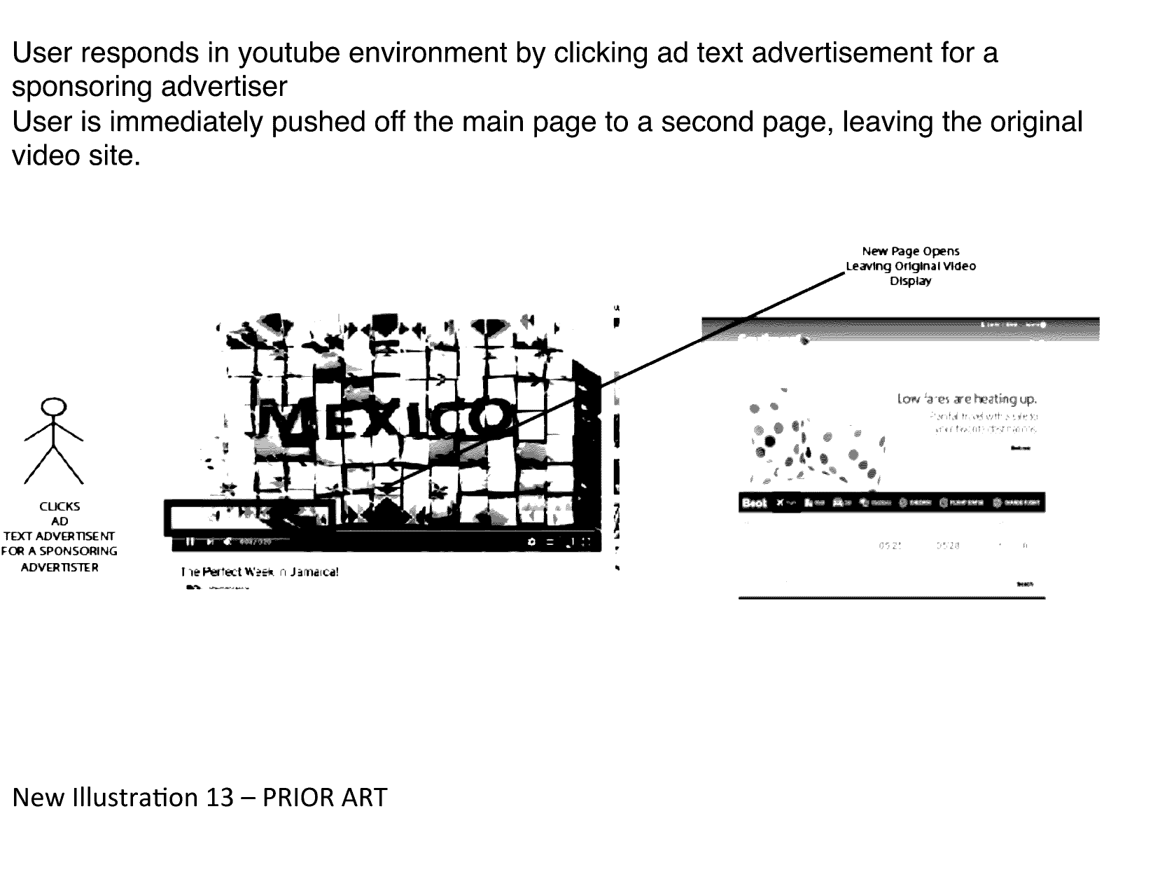

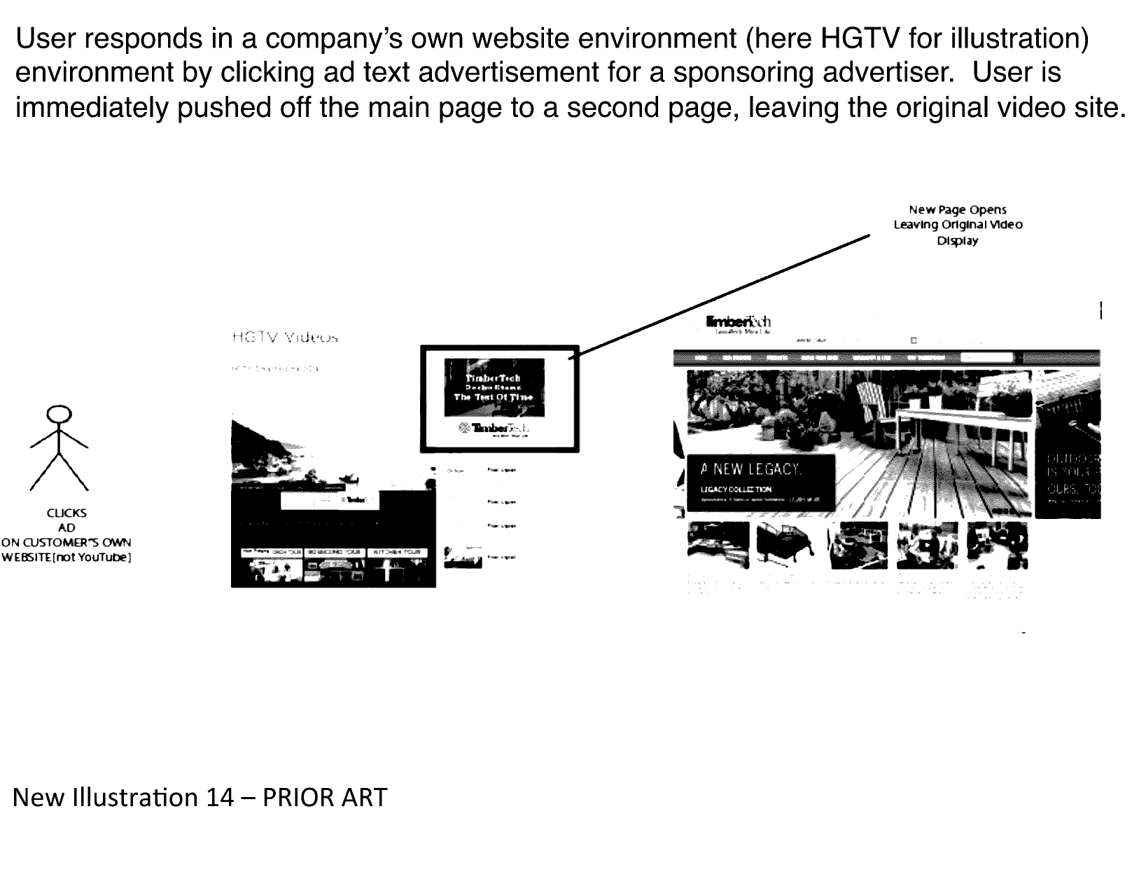

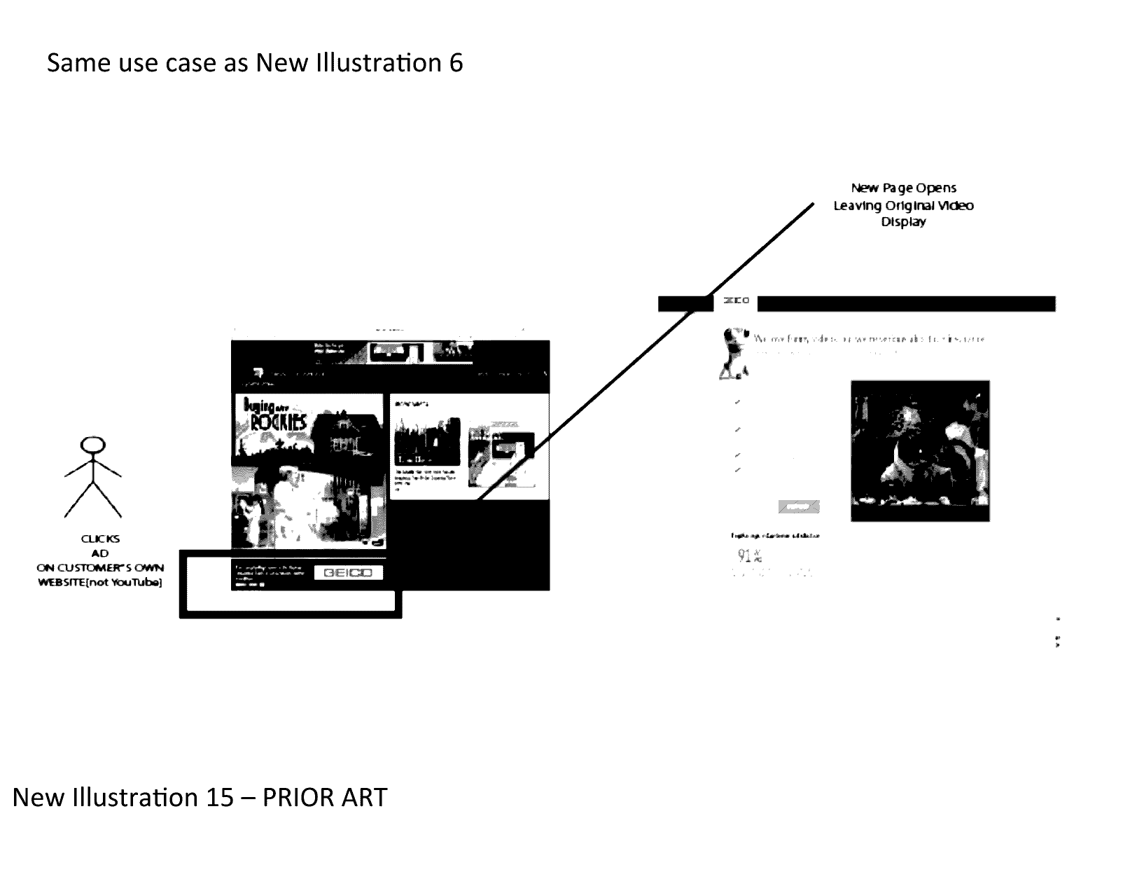

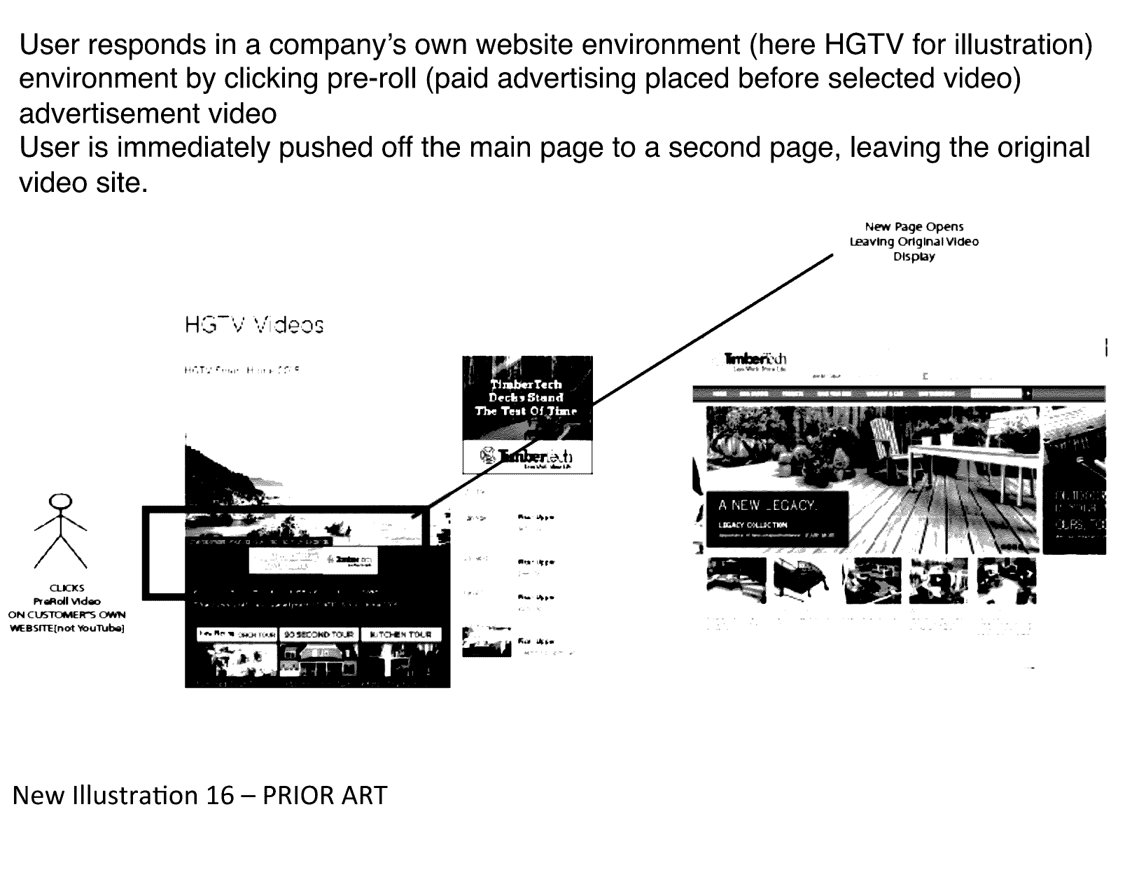

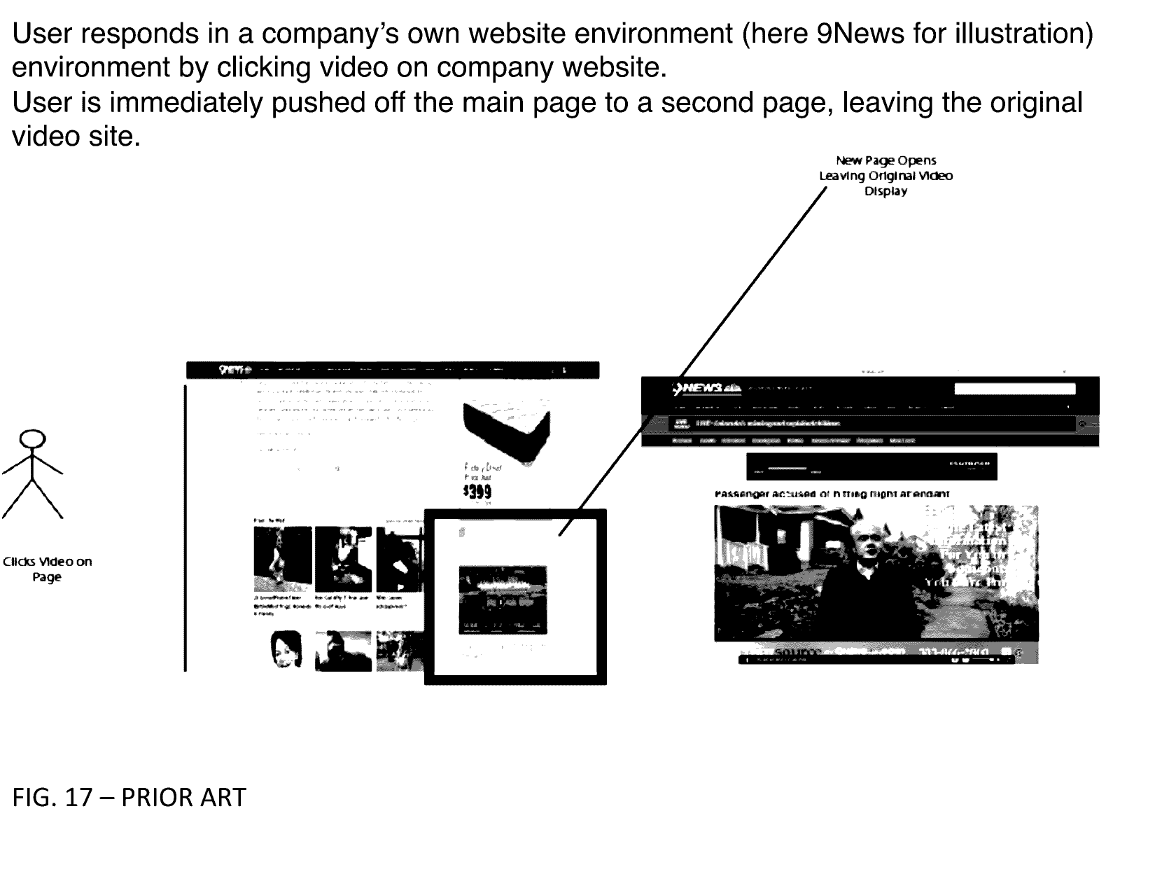

With reference to FIG. 8, a state diagram of the shop by video portal is shown. In step 400, the user creates the account, by entering customer information such as login/password, credit card information, and agreement to terms of service. In step 405 the user then uploads videos, such as YOUTUBE embedded videos, and hits save and enter. In step 410 the user enters the shop by video portal, which provides a dedicated URL for the page, displays the entered name, main video and other associated or selected videos. In step 415 the ecommerce unit bills the client monthly, through credit card or other payment means, using data security and providing a cancellation option.

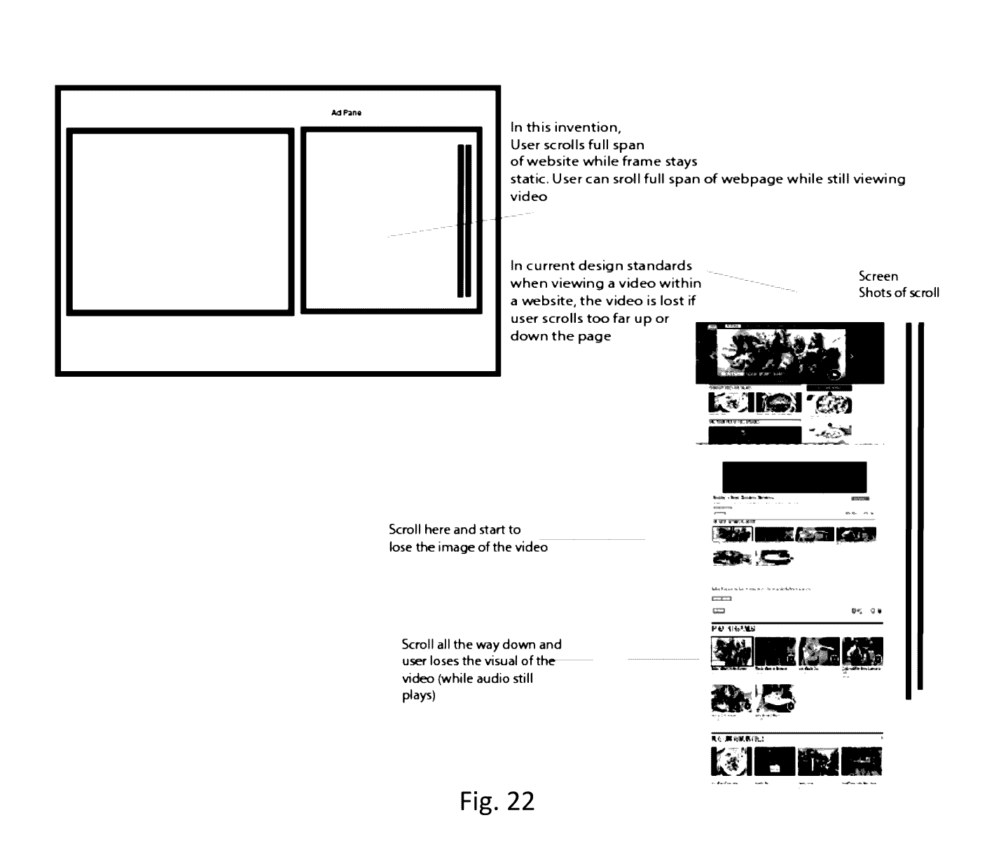

With reference to FIG. 22, an optional scroll view feature is shown, wherein the user may scroll the full span of the website within the ad pane while the ad pane stays locked in a position, and while the video continues to play. In prior art, the web page contains the video, and if the web page is scrolled the video may pass off the top of the screen. An example of this is shown on the right side of the figure.

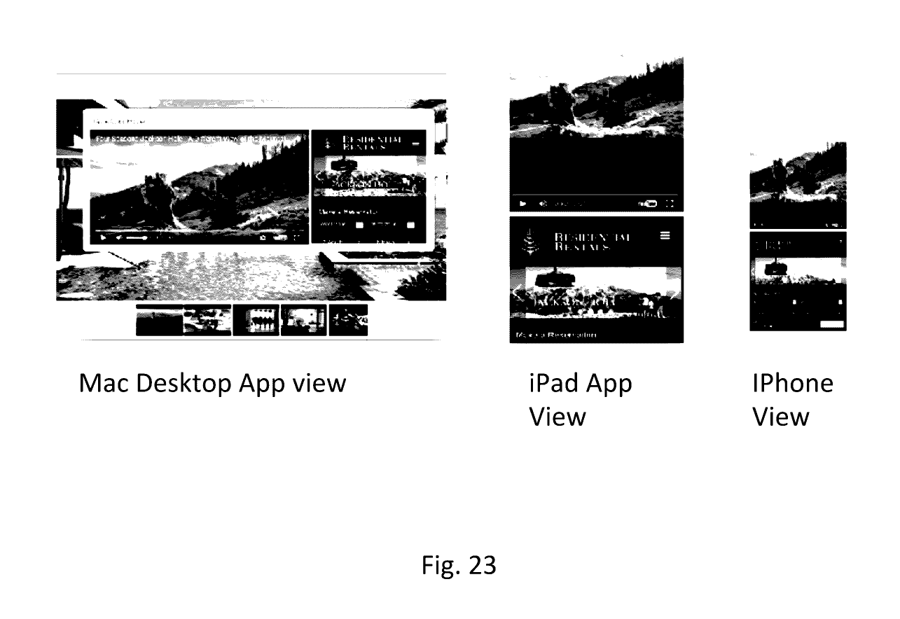

With reference to FIG. 23, a number of screen formats for the system are shown. Sample of mobile and app extensions of inventions. Because of “thin” design, the invention also functions on a variety of devices in addition to standard web browser including: i) mobile browsers (url access from Smart Phone), ii) iOS Apps including (to be made available on Apple App Store) a Mac Desktop App, an iPhone App, an iPad App, a DROID App (available of Google Play), and Smart TV Applications. Below is a summary of these display across multiple devices

| Device | Programmed In | Inventions displays in |
|---|---|---|
| Standard Web | HTML 5, CSS, | Web sites on computer |
| | Javascript MYSQL | |
| Mobile Devices | HTML 5 | Mobile device (phone or |
| | | table] through web browser |
| iOS Apps | XCODE | Mac's Desktop App, iPhone, |
| | | iPad. Available for download |
| | | on Apple App Store |
| Droid Apps | Android Studio | Window's devices, including |
| | | instances of Window's 10. |
| | | Available through Google |
| | | Play |
| Television | Misc | Web browser on Smart TV |
| | | and/or Custom Smart TV |
| | | Apps |

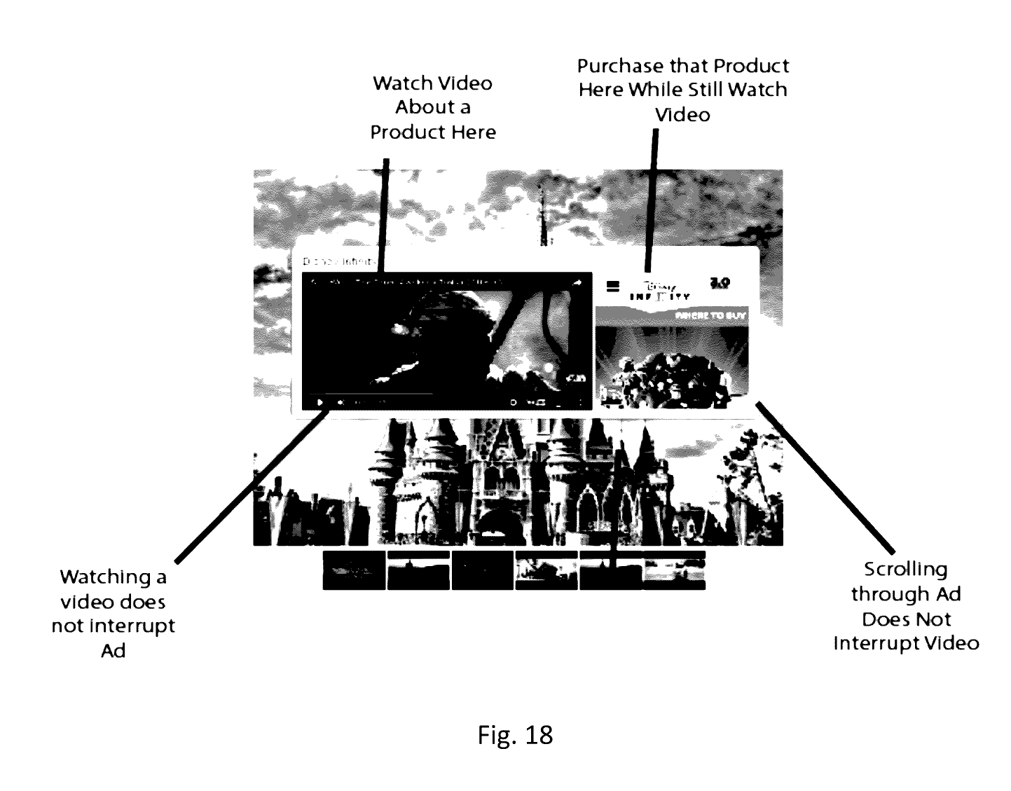

Some benefits of the invention are shown in FIG. 18, wherein the user may watch video about a product in the left-most pane, and consume information about that product and purchase the product in a right-most pane while still watching the video. Watching the video does not interrupt the ad, and scrolling through the ad material does not interrupt the video.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A method of using an interactive video system, comprising the steps of:
a. a user opening a promotional page comprising at least one video pane containing video content, and an ad pane containing web content;
b. the user watching at least one video while interacting with the web content of the ad pane, wherein the user scrolls through the web content and selects a link that interests the user; and
c. the ad pane switching to the linked page when the link is selected, wherein the video content continues playing uninterrupted and the web content is retrieved from a server.

2. The method of using an interactive video system of claim 1, further comprising the step of the user viewing a list of one or more videos relating to the video content.

3. The method of using an interactive video system of claim 2 further comprising the step of the user switching between videos shown on the video list by clicking on them.

4. The method of using an interactive video system of claim 1 wherein web content is html content.

5. The method of using an interactive video system of claim 1 wherein a link to the content or to the video is shared by the user with one or more other users.

6. The method of using an interactive video system of claim 1 wherein the server is a remote server.

7. The method of using an interactive video system of claim 1 wherein the video content is provided by a remote server.

8. The method of using an interactive video system of claim 1 wherein the ad pane content changes according to a pre-determined schedule.

9. The method of using an interactive video system of claim 1 wherein the ad pane content changes according to the video content that is playing.

10. A system for providing interactive video, comprising:
a. at least one video pane containing video content that is playing;
b. at least one ad pane comprising web content;
c. a background on which the video pane and ad pane are positioned;
wherein a user interacts with the web content, wherein when links are clicked the web content changes while the video continues playing.

11. The system for providing interactive video of claim 10 wherein the video pane usage statistics are tracked.

12. The system for providing interactive video of claim 10 wherein the ad pane usage statistics are tracked.

13. The system of claim 10 further comprising a video selection bar, from which a user may select a selected video, and wherein the video pane changes to show the selected video.

14. The system of claim 10, wherein the ad pane is connected to a real-time booking engine.

15. The system of claim 10, wherein the ad pane content changes according to a pre-determined schedule.

16. The system of claim 10, wherein the ad pane content changes according to the video content that is playing.
